(19) United States
(12) Patent Application Publication
(10) Pub. No.: US 2018/0165998 A1
(43) Pub. Date: Jun. 14, 2018

(54) OMNIDIRECTIONAL FLYING VISUAL APPARATUS

(71) Applicant: Carl D. Bogan, III, Los Angeles, CA (US)

(72) Inventor: Carl D. Bogan, III, Los Angeles, CA (US)

(21) Appl. No.: 15/833,972

(22) Filed: Dec. 6, 2017

Related U.S. Application Data
(60) Provisional application No. 62/432,510, filed on Dec. 9, 2016.

(51) Int. Cl. G09F 21/08; B64C 39/02; G05D 1/00; G09F 19/18

(52) U.S. Cl. CPC G09F 21/08; B64C 39/024; G05D 1/0011; G01S 19/13; B64C 2201/027; B64C 2201/108; B64C 2201/146; G09F 19/18

(57) ABSTRACT

An omnidirectional flying apparatus for displaying video content and static signage to grab attention, interact with people, and convey messages. A flight system including an unmanned aerial vehicle having a plurality of individually rotatable propellers configured to provide thrust and enable the apparatus to fly is mounted on a structural assembly. The structural assembly is configured to hold an array of signage providing a 360 degree visual display. The apparatus provides lightweight screens utilizing at least one projector to display the video content. At least one input/output device is configured to enable a user to program a flight path of the unmanned aerial vehicle and select video content to be displayed.

### CROSS-REFERENCE TO RELATED APPLICATIONS

The present application claims the benefit of U.S. Provisional Application Ser. No. 62/432,510, filed on Dec. 9, 2016 entitled “OMNIDIRECTIONAL FLYING JUMBOTRON”, the disclosure of which is hereby incorporated in its entirety at least by reference.

### BACKGROUND OF THE INVENTION

### 1. Field of the Invention

The present invention generally relates to mobile advertising, but more particularly to a drone-assisted omnidirectional visual apparatus.

### 2. Description of Related Art

In today's world of distractions, it has become increasingly more difficult to impart or exchange information on a large scale to a wide range of people. For example, with the proliferation of mobile devices, it has become increasingly difficult to grab the attention of a large number of people, whether for public service announcements, advertisements/promotions of products or services, or any other purposes of communication.

Conventionally, marketers, advertisers and other communicators have relied on outdoor signage to convey a message. Examples of commonly used outdoor signage include, but are not limited to, static billboards, digital billboards, signage affixed to bus benches, kiosks located at shopping centers, etc. When first introduced as a means of mass communication, billboards were effective in grabbing attention and conveying a message. With the ubiquity of outdoor signage over the years, people have become desensitized to billboards and other types of commonly used outdoor signage, typically turning a blind eye to such signage. As billboards and other types of commonly used outdoor signage have fallen flat and become stale, their effectiveness in grabbing attention and conveying a message has been reduced and diminished. Some have utilized drones to fly traditional static signage, such as banners, that are attached to the bottom of the drones; conveying a message in this manner, however, is similarly ineffective.

Furthermore, advertisers typically adopt a “shotgun approach” in which a general message is broadcast to everyone simultaneously. Most commonly used outdoor signage display a general message instead of a message targeting a specific group of people as advertisers are unable to predict who will be in the vicinity of the message (e.g., who will drive by, walk by, or bike by the message). Targeted advertising and messaging is difficult to execute and may not fully capture a targeted or intended audience. As commonly used outdoor signage does not effectively capture the attention of and desired interaction with a targeted or intended audience, such signage fails to engage with the targeted or intended audience on an impactful scale. For example, it is unlikely that signage affixed to a bus bench will prompt an individual to take a photo of the signage using his/her mobile device and share the photo on social media, thereby garnering more views for the signage. There are no existing solutions that resolve these and other similar issues described above. Consequently, there is a need for an omnidirectional flying visual apparatus.

### BRIEF SUMMARY OF THE INVENTION

In one embodiment an omnidirectional flying visual apparatus is provided, comprising a flight system including an unmanned aerial vehicle having a plurality of individually rotatable propellers configured to provide thrust and enable the apparatus to fly, wherein each propeller of the plurality of individually rotatable propellers includes a motor configured to power each propeller; an array of signage; and a structural assembly configured to secure and mount the flight system and the array of signage.

In one embodiment, the array of signage includes at least one screen for displaying video content. In one embodiment, at least one projector is provided to apply rear projection to the at least one screen to display video content. In one embodiment, at least one projector mount is provided to affix the at least one projector to the structural assembly. In another embodiment, the array of signage includes at least one static signage. In one embodiment, the structural assembly comprises a plurality of support members and the at least one screen is removably attached to the plurality of support members via a plurality of fasteners. In yet another embodiment, the array of signage is arranged to form an octagonal shape. In one embodiment, the motor is controlled via a remote control device configured to be operated by a user. In another embodiment, the displayed video content is targeted advertising. In one embodiment, the flight system includes a GPS module configured to track locational coordinates of the apparatus during operation and the displayed video content is configured to change based on the locational coordinates. In yet another embodiment, the at least one static signage is at least one banner.

In another aspect of the invention, an omnidirectional flying visual apparatus is provided, comprising a flight system including an unmanned aerial vehicle having a plurality of individually rotatable propellers configured to provide thrust and enable the apparatus to fly, wherein each propeller of the plurality of individually rotatable propellers includes a motor configured to power each propeller; an array of signage comprising a plurality of projection screens and a plurality of static signage, wherein the array of signage is configured to provide a 360 degree visual display; a plurality of projectors configured to apply rear projection to the plurality of projection screens to display video content; and a structural assembly configured to secure and mount the flight system and the array of signage, wherein the structural assembly comprises a plurality of support members and the array of signage is removably attached to the plurality of support members via a plurality of fasteners.

In one embodiment, the plurality of individually rotatable propellers are attached to the plurality of support members via brackets. In one embodiment, the array of signage is arranged to form an octagonal shape and the octagonal shape includes eight sides wherein each side is configured to maintain an interior angle of 135 degrees with an adjacent side forming the octagonal shape. In one embodiment, the eight sides are either a projection screen of the plurality of projection screens or a static sign of the plurality of static signage. In another embodiment, a flight controller, a memory, a processor, at least one input/output device, a projector controller, and a transceiver are provided. In one embodiment, the flight controller is configured to control a flight path of the unmanned aerial vehicle. In one embodiment, the flight path is a preprogrammed flight path or based on control signals from a remote control device configured to be operated by a user. In one embodiment, the at least one input/output device is configured to enable a user to program a flight path of the unmanned aerial vehicle. In another embodiment, the at least one input/output device is configured to enable a user to select video content to be displayed the plurality of projection screens.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a front view of an omnidirectional flying visual apparatus according to an embodiment of the present invention.

FIG. 2 is a bottom view of a portion of the omnidirectional flying visual apparatus according to an embodiment of the present invention.

FIG. 3 is a top view of a portion of the omnidirectional flying visual apparatus according to an embodiment of the present invention.

FIG. 4 is a top view of a portion of the omnidirectional flying visual apparatus according to an embodiment of the present invention.

FIG. 5 is a top view schematic of the omnidirectional flying visual apparatus according to an embodiment of the present invention.

FIG. 6 is block diagram of the omnidirectional flying visual apparatus according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide an omnidirectional flying visual apparatus.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

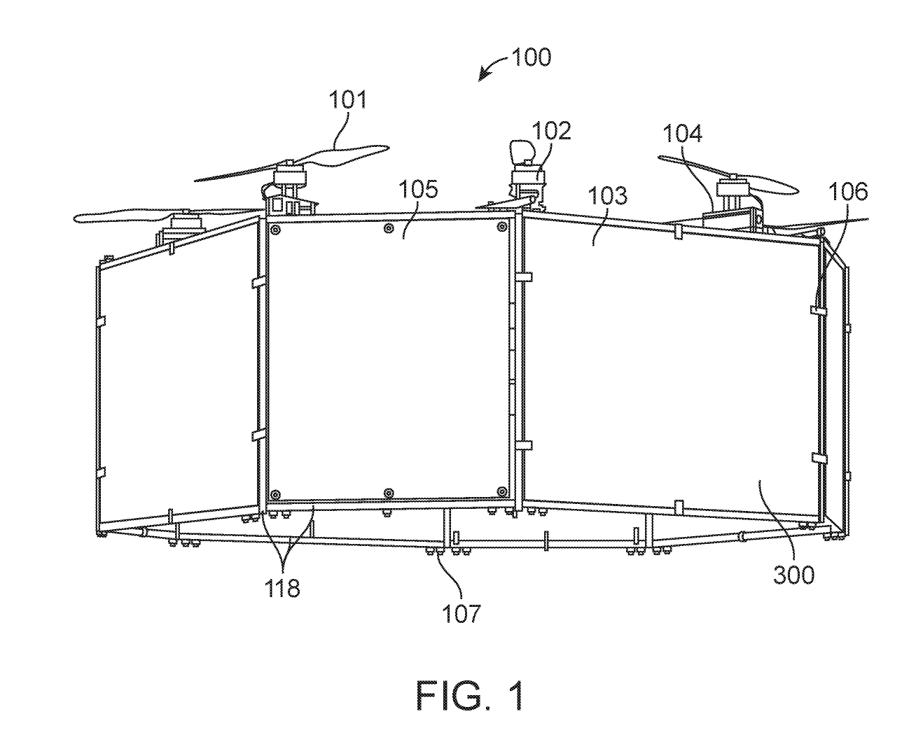

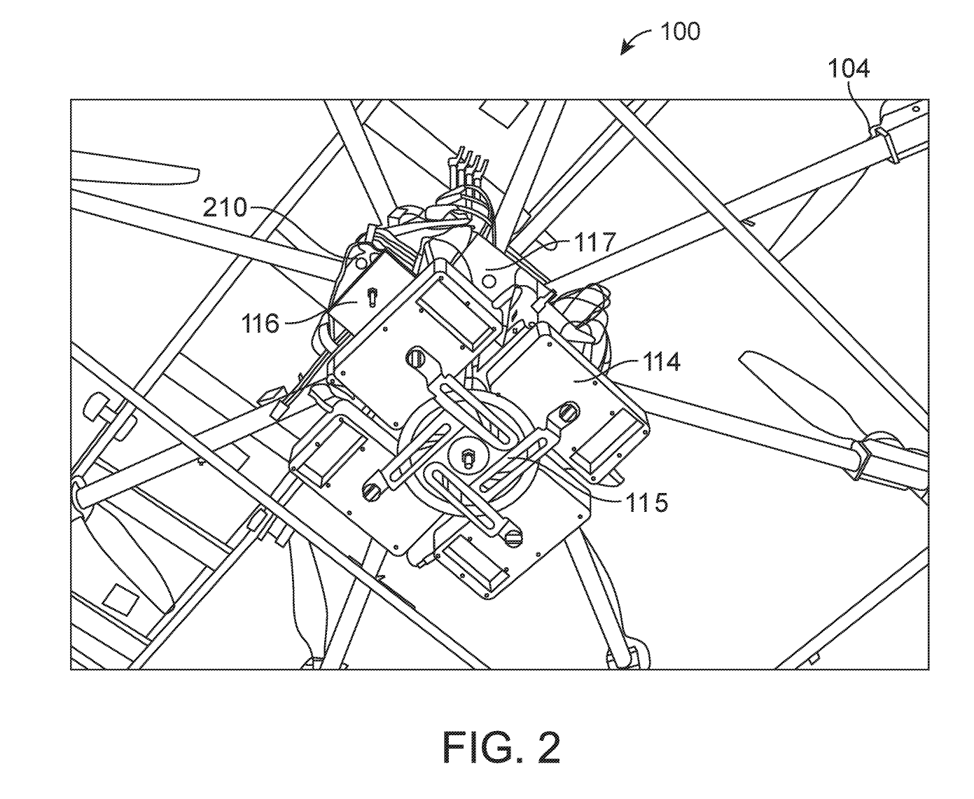

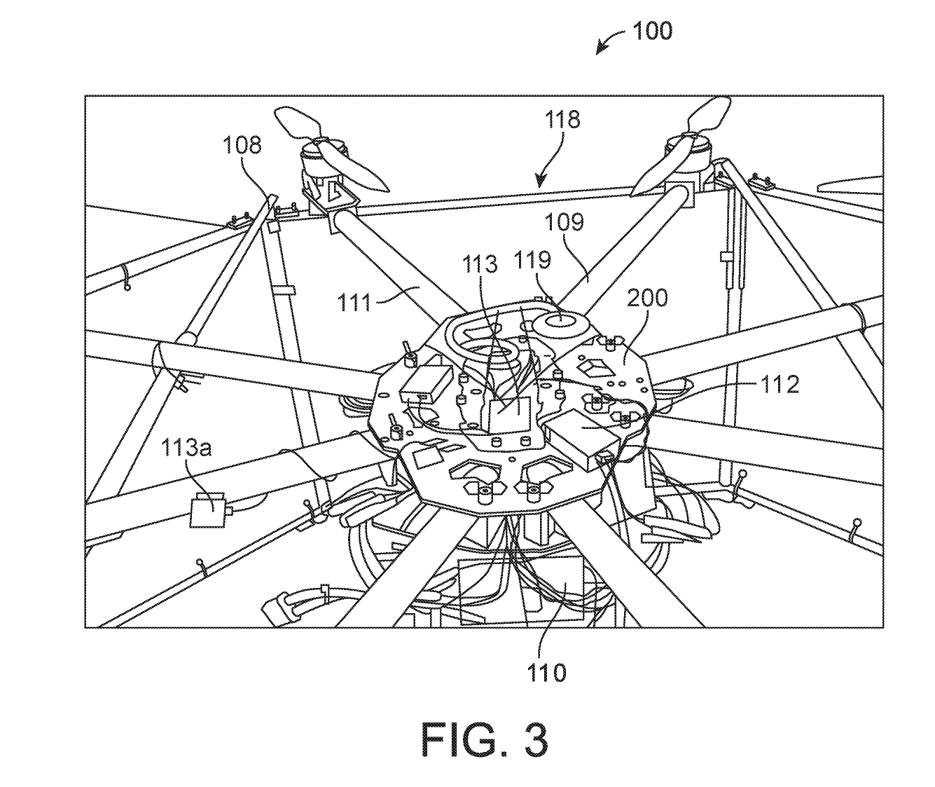

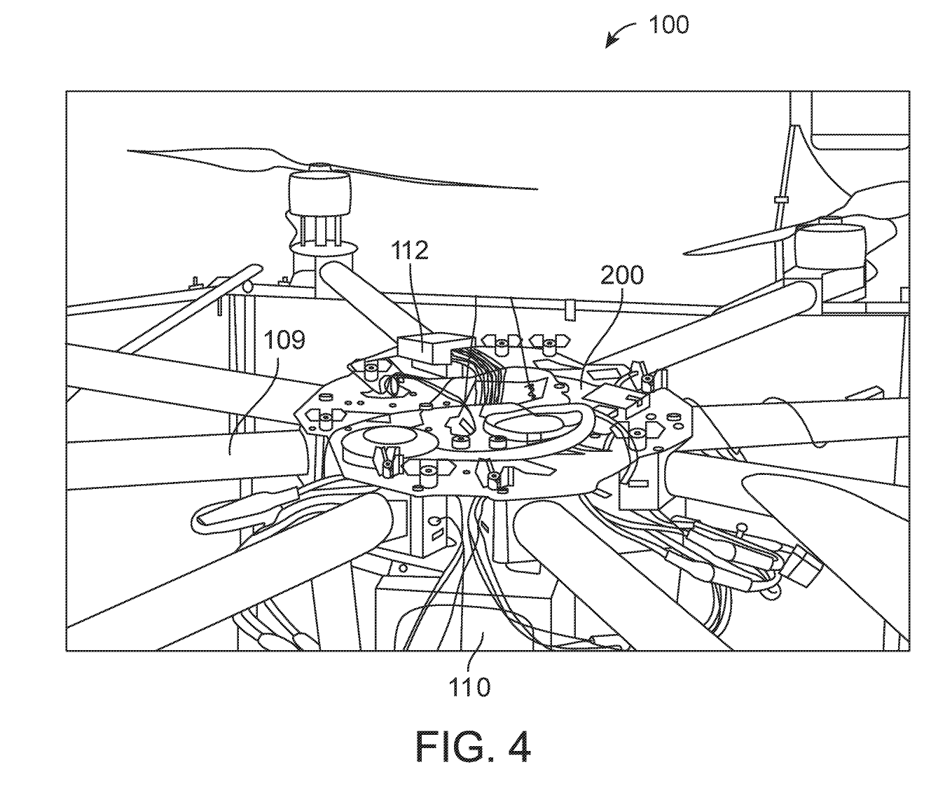

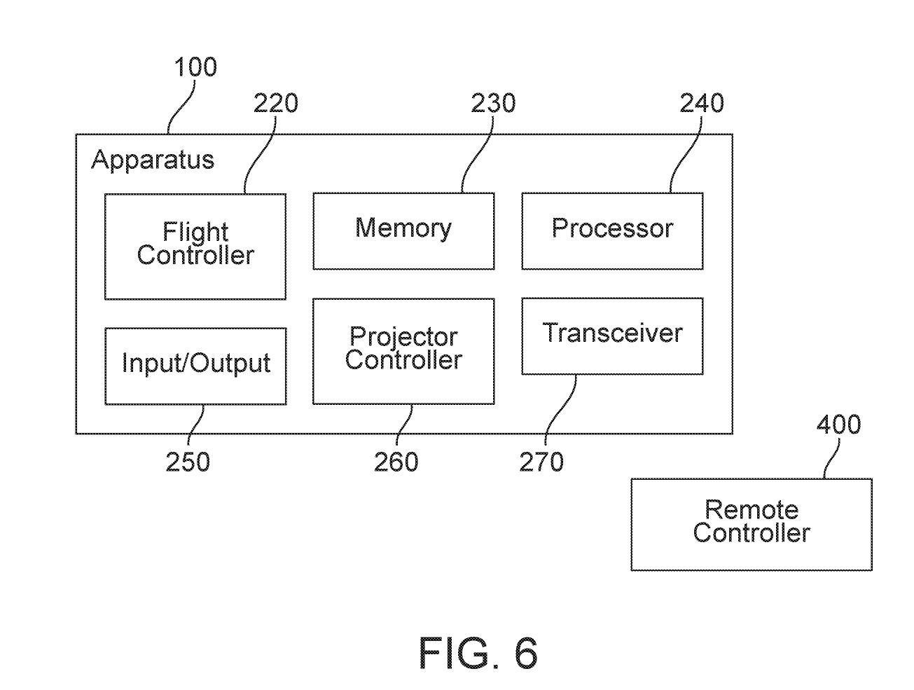

With reference to FIGS. 1-6, embodiments of an omnidirectional flying visual apparatus 100 are provided. The omnidirectional flying visual apparatus comprises a structural assembly 118, flight system 200 and a visual projection system 300. The structural assembly provides a framework connecting and mounting the flight system to the visual projection system. The structural assembly includes support members 108, 109, and 111. In one embodiment, the support members are constructed from a rigid lightweight material, such as carbon fiber tubes. The flight system includes an unmanned aerial vehicle (UAV) or drone 210 enabling the apparatus to fly. In one embodiment, the drone comprises a plurality of individually rotatable propellers 101 configured to provide thrust as well known in the art. In one embodiment, the plurality of individually rotatable propellers are attached to the drone via support members 109, 111, and brackets 104. Each propeller of the plurality of individually rotatable propellers includes a motor 102 configured to power the propellers. In one embodiment, the motor is controlled via a remote control device 400 configured to be operated by a user. The remote control device will be discussed in greater detail below.

It is a particular advantage of the present invention to maximize flight time of the apparatus. Thus, many factors are considered including but not limited to, the unmanned aerial vehicle type selection, size of the plurality of individually rotatable propellers, brushless motor type of the motors, length of the support members, and the overall size and weight of the apparatus when stationary and in flight. In one embodiment, the unmanned aerial vehicle is a heavy-lift drone. In one embodiment, each propeller of the plurality of individually rotatable propellers is large in size to provide the necessary thrust to carry the weight of the apparatus during operation. In one embodiment, the apparatus is 54 inches in diameter and 20 inches in height, however it is understood that the size may vary.

The visual projection system comprises an array of signage and at least one projector 114. In one embodiment, the array of signage includes at least one screen 103. In one embodiment, the array of signage may include at least one static signage. Preferably, the at least one screen is constructed from a lightweight fabric material, i.e. a projection screen. It should be understood, that any projector screen material may be selected for the visual projection system depending on the desired features of the material, including but not limited to flexibility, material grain, ambient light absorption, color, and mildew resistance. Specifically, due to the at least one screen's exposure to environmental conditions, such as weather and sunlight, a variety of projection screen materials may be selected depending on these conditions. In one embodiment, the at least one screen is constructed from an unbreakable polycarbonate coated with rear projection film configured to capture projected light from the at least one projector rendering a viewable display on the at least one screen. In one embodiment, the at least one static signage is at least one banner or similar static signage. Alternatively, the at least one projector is configured to display video content on the at least one screen. The at least one projector applies rear projection generating video content viewable on the front portion of the at least one screen. It is a particular advantage of the present invention to use the at least one protector to display video contact rather than LCD or LED screens, as the at least one screen and at least one projector combination is much lighter in weight and requires less power than LCD or LED screens. In one embodiment, at least one projector mount 115 is used to affix the at least one projector to the structural assembly.

In one embodiment, the at least one projector is small in size having a high lumen rating as well known in the art. A battery tray 116 is provided for securing at least one battery 110 for the at least one projector. In one embodiment, the at least one battery is a lithium polymer battery. In alternative embodiments, the at least one projector is powered by another component of the apparatus, such as the unmanned aerial vehicle.

It is a particular advantage of the present invention, that the apparatus may be quickly assembled and disassembled for ease of transport. Thus, each screen of the at least one screen is removably attached to support members 108 of the structural assembly via fasteners 106. Similarly, the at least one static signage is removably attached to support members 108 of the structural assembly via fasteners 106. In one embodiment, the fasteners are fabric hook and loop fasteners, such as Velcro® straps, enabling each of the at least one screen and at least one static signage to be individually removed and installed to the structural assembly easily. Although fabric hook and loop fasteners are preferred, it should be understood that another type of fasteners may be used, such as screws, snaps, magnets or any type of releasable fasteners known in the art.

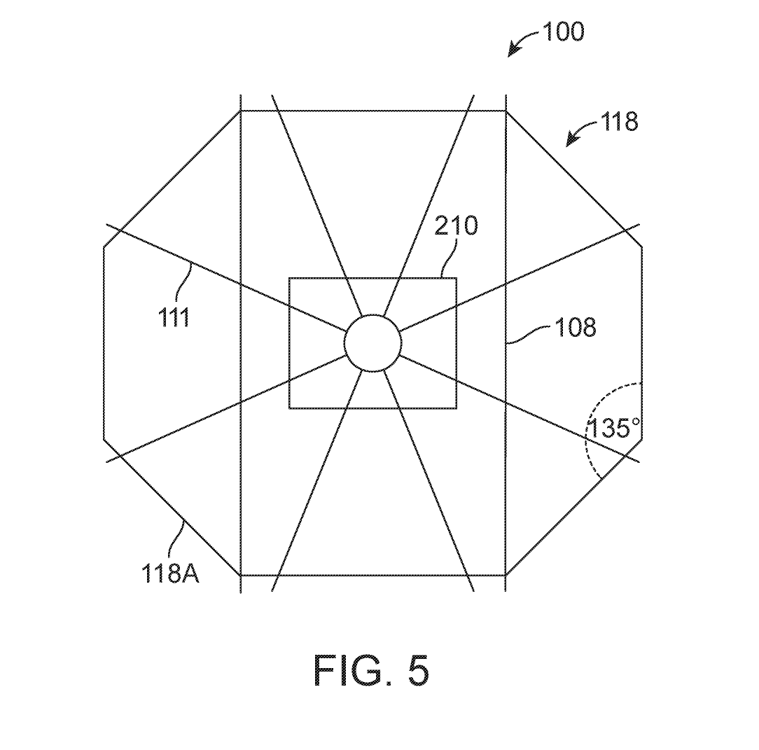

Preferably, there are four projectors and four corresponding screens configured to encircle the outer portion of the structural assembly such that video content is viewable on every side of the apparatus. Best seen in FIG. 5, the outer portion of the structural assembly and array of signage is arranged to form an octagonal shape with eight different sides 118A. Each side is configured to maintain an interior angle of 135 degrees with an adjacent side forming the octagonal shape as illustrated. Preferably, this configuration provides a 360 degree visual display, wherein each side includes either a screen or a static signage. In one embodiment, brackets 107 are positioned to connect each adjacent side to help maintain and secure the interior angle. In one embodiment, the brackets are made from 3D printing. In one embodiment, the screens and the static signage are arranged to surround the unmanned aerial vehicle on multiple sides such that the unmanned aerial vehicle is partially obscured.

During operation, the apparatus displays video content on the at least one screen while in flight to grab attention, interact with people, and convey messages. It is a particular advantage of the present invention to act as a flying jumbotron to incite attention from spectators while encouraging the spectators to engage and interact with the displayed video content. For instance, the apparatus provides an interactive experience as it is likely to prompt spectators to capture a photo of the apparatus in flight using their mobile device. The apparatus is visually prominent, easily catching the attention of anyone in its vicinity providing higher visibility. The apparatus can be utilized for a variety of uses including but not limited to large scale gatherings, such as sporting events, concerts, festivals, and fairs either inside arenas or outside. In one embodiment, the apparatus provides a cost-effective solution for targeted advertising. For instance, the apparatus may be operated at public or private events to display specific content for specific groups of people at specific times, such as advertising refreshments at a sporting event.

In one embodiment, the flight system includes a global positioning system (GPS) module 119. In one embodiment, the video content displayed on the at least one screen may change based on location coordinates of the apparatus.

In one embodiment, the apparatus may include a flight controller 220, a memory 230, a processor 240, at least one input/output (I/O) device 250, a projector controller 260, and a transceiver 270. The flight controller is configured to control a flight path of the unmanned aerial vehicle, wherein the flight path is a preprogrammed flight path or based on control signals from the remote control device. In one embodiment, the flight controller is integrated in the unmanned aerial vehicle. In alternative embodiments, the flight controller is separate from the unmanned aerial vehicle. In one embodiment, the flight controller comprises an electronic speed controller 117 for controlling the speed of the unmanned aerial vehicle in flight. In one embodiment, the at least one input/output device may include but is not limited to a keypad, a button, a switch, and a display screen. A user may interact with the at least one input/output device to provide input to the apparatus. For instance, the at least one input/output device may be used to program a flight path or for uploading and selecting video content to be displayed on at the at least one screen. In one embodiment, the memory maintains data, such as preferred user settings, default settings, preprogrammed flight plans, or preprogrammed playlists of video content.

The transceiver is configured to wirelessly receive signals and transmit signals to the remote control device operated by the user, such as radio frequency signals. In one embodiment, the signals can be used to control the flight path as well as for controlling the video content displayed on the at least one screen. In one embodiment, the transceiver comprises a radio receiver 112, a radio transmitter 113, and a radio transmitter status indicator 113a.

The projector controller is configured to control video content displayed on the at least one screens. Specifically, the projector controller controls the video content displayed based on the preprogrammed playlists of video content or signals received from the remote control device. In one embodiment, the projector controller is integrated in a projector of the at least one projector. In another embodiment, the projector controller is separate from the at least one projector.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, although the apparatus and structural assembly is arranged to form an octagonal shape, other arrangements may be implemented such as a circle, square, or rectangle.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An omnidirectional flying visual apparatus comprising:
a flight system including an unmanned aerial vehicle having a plurality of individually rotatable propellers configured to provide thrust and enable the apparatus to fly, wherein each propeller of the plurality of individually rotatable propellers includes a motor configured to power each propeller;
an array of signage; and
a structural assembly configured to secure and mount the flight system and the array of signage.

2. The omnidirectional flying visual apparatus of claim 1, wherein the array of signage includes at least one screen for displaying video content.

3. The omnidirectional flying visual apparatus of claim 2, further comprising at least one projector configured to apply rear projection to the at least one screen to display video content.

4. The omnidirectional flying visual apparatus of claim 3, further comprising at least one projector mount configured to affix the at least one projector to the structural assembly.

5. The omnidirectional flying visual apparatus of claim 1, wherein the array of signage includes at least one static signage.

6. The omnidirectional flying visual apparatus of claim 2, wherein the structural assembly comprises a plurality of support members and the at least one screen is removably attached to the plurality of support members via a plurality of fasteners.

7. The omnidirectional flying visual apparatus of claim 1, wherein the array of signage is arranged to form an octagonal shape.

8. The omnidirectional flying visual apparatus of claim 1, wherein the motor is controlled via a remote control device configured to be operated by a user.

9. The omnidirectional flying visual apparatus of claim 3, wherein the displayed video content is targeted advertising.

10. The omnidirectional flying visual apparatus of claim 3, wherein the flight system includes a GPS module configured to track locational coordinates of the apparatus during operation and the displayed video content is configured to change based on the locational coordinates.

11. The omnidirectional flying visual apparatus of claim 5, wherein the at least one static signage is at least one banner.

12. An omnidirectional flying visual apparatus comprising:
a flight system including an unmanned aerial vehicle having a plurality of individually rotatable propellers configured to provide thrust and enable the apparatus to fly, wherein each propeller of the plurality of individually rotatable propellers includes a motor configured to power each propeller;
an array of signage comprising a plurality of projection screens and a plurality of static signage, wherein the array of signage is configured to provide a 360 degree visual display;
a plurality of projectors configured to apply rear projection to the plurality of projection screens to display video content; and
a structural assembly configured to secure and mount the flight system and the array of signage, wherein the structural assembly comprises a plurality of support members and the array of signage is removably attached to the plurality of support members via a plurality of fasteners.

13. The omnidirectional flying visual apparatus of claim 12, wherein the plurality of individually rotatable propellers are attached to the plurality of support members via brackets.

14. The omnidirectional flying visual apparatus of claim 12, wherein the array of signage is arranged to form an octagonal shape and the octagonal shape includes eight sides wherein each side is configured to maintain an interior angle of 135 degrees with an adjacent side forming the octagonal shape.

15. The omnidirectional flying visual apparatus of claim 14, wherein the eight sides are either a projection screen of the plurality of projection screens or a static sign of the plurality of static signage.

16. The omnidirectional flying visual apparatus of claim 12, further comprising a flight controller, a memory, a processor, at least one input/output device, a projector controller, and a transceiver.

17. The omnidirectional flying visual apparatus of claim 16, wherein the flight controller is configured to control a flight path of the unmanned aerial vehicle.

18. The omnidirectional flying visual apparatus of claim 17, wherein the flight path is a preprogrammed flight path or based on control signals from a remote control device configured to be operated by a user.

19. The omnidirectional flying visual apparatus of claim 16, wherein the at least one input/output device is configured to enable a user to program a flight path of the unmanned aerial vehicle.

20. The omnidirectional flying visual apparatus of claim 16, wherein the at least one input/output device is configured to enable a user to select video content to be displayed the plurality of projection screens.
